(19) United States
(12) Patent Application Publication
(10) Pub. No.: US 2015/0149314 A1
(43) Pub. Date: May 28, 2015

(54) ACTIVE TRANSACTION RECEIPTS

(71) Applicant: RED GIANT, INC., PALO ALTO, CA (US)

(72) Inventor: ROBERT KERN SEARS, Palo Alto, CA (US)

(21) Appl. No.: 14/550,570

(22) Filed: Nov. 21, 2014

Related U.S. Application Data
(60) Provisional application No. 61/907,876, filed on Nov. 22, 2013.

(51) Int. Cl. G06Q 20/20

(52) U.S. Cl. CPC G06Q 20/209
USPC 705/24

(57) ABSTRACT

A system for collecting data relating to a transaction and generating an active transaction receipt is disclosed. An active transaction receipt that includes one or more objects that may be displayed on a computing device is disclosed. One or more of the objects may dynamically change based on the data relating to the transaction. One or more of the objects may dynamically change based on input from a user.

### CROSS-REFERENCE TO RELATED APPLICATION

This application claims priority to U.S. provisional application No. 61/907,876, filed Nov. 22, 2013, which application is incorporated herein by reference, in its entirety, for any purpose.

The entire disclosure of the prior application, from which a copy of the oath or declaration is supplied, is considered to be part of the disclosure of the instant application.

### BACKGROUND

Traditionally, receipts for financial transactions are static documents containing some form of report of the details of the related transaction. Details may include merchant name, date of transaction, amount of transaction, items purchased, amount of cash returned to customer, and so on. For many years, receipts were simply paper documents. In recent years, however, receipts have been developed in various electronic forms. For example, Electronic Data Interchange (EDI) and Electronic Receipt (e-receipt) systems have been developed to present receipts in electronic form in an organized way such that the data in the receipts may be processed automatically for any number of purposes, including inventory management, expense accounting, compliance, and so on.

In all of these systems, a receipt is either a static, tangible document, or it is a static disembodied collection of data that is ultimately presented to a user in physical form, displayed on the screen of a computer or mobile device, sent in an email message or delivered in some manner similar to these.

None of these receipt types take advantage of computing power or connectivity typically available on devices to which receipts are delivered.

### BRIEF DESCRIPTION OF THE DRAWINGS

FIG. 1 is a schematic illustration of an example of a traditional receipt.

FIG. 2 is a schematic illustration of an example electronic receipt.

FIG. 3 is a schematic illustration of a payment system according to an embodiment of the invention.

FIG. 4 is a schematic illustration of a mobile application according to an embodiment of the invention.

FIG. 5 is a schematic illustration of an active transaction receipt according to an embodiment of the invention.

FIG. 6 is a schematic illustration of an active transaction receipt according to an embodiment of the invention.

FIG. 7 is a schematic illustration of an active transaction receipt according to an embodiment of the invention.

### DETAILED DESCRIPTION

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known mobile device components, hardware, software, and processes have not been described or shown in detail in order to avoid unnecessarily obscuring the invention.

An Active Transaction Receipt (ATR), as described herein, may adapt its presentation and/or its behavior to provide capabilities and functionality beyond the simple delivery of data regarding an associated transaction. Instead of being a static or fixed document, object, collection of objects, or set of data, an ATR may be a malleable object or set of objects that may change appearance, interactivity, and/or other behaviors based on data related to the transaction (“transaction data”) and, optionally, based on information that describes context of the transaction (“contextual information”).

A financial transaction may be described by a set of data including, but not limited to, the amount of the transaction, a representation of the time at which the transaction was initiated, the time at which the transaction was settled, and descriptions of the parties to the transaction. For example, when a payment card (e.g., a credit card or debit card) is used at a point of sale terminal (POS), the POS will commonly send data to a centralized server (e.g., centralized payment authorization server), the data being a representation of the transaction data and often formatted in accordance with the ISO-8583 standard. The ISO-8583 standard defines fields for critical information, such as the number of the card used to initiate the transaction, the POS at which the transaction was performed, the identity of the merchant, the time at which the transaction was initiated, the zip code in which the POS is located, the amount of the transaction, the currency in use, the type of merchant, and the method by which the card number was entered (e.g., magnetic swipe read, manual keypad entry). This information is called here “network transaction data” and is provided to the central payment authorization server and may be analyzed in order to determine whether the transaction should be authorized or declined. The centralized payment authorization server may determine whether to authorize or decline the payment transaction and may then communicate this determination to the POS using similarly-formatted data (“response data”).

A transaction does not take place in abstract isolation, and instead, it takes place in a context. The description of context may be captured as additional data, herein called contextual information. For a transaction initiated via physical POS, for instance, contextual information may include, but is not limited to, a description of whether the cardholder was present or was not present, a description of the physical state of the POS equipment whether the POS was attended or unattended, a notation reflecting whether the transaction was handled using a signature network (i.e., one of the payment networks owned by the major payment card associations such as Visa, MasterCard or American Express), and/or an indication as to whether the customer used a PIN keypad.

Contextual information may contain information obtained from sources not directly connected to the POS. For example, a payment system (e.g., Square Register) that encompasses a mobile application running on a smartphone may deliver geographical coordinates, an electronic representation of the customer's signature, a photograph or other information that is ancillary to, but related to, the transaction, and the transaction data.

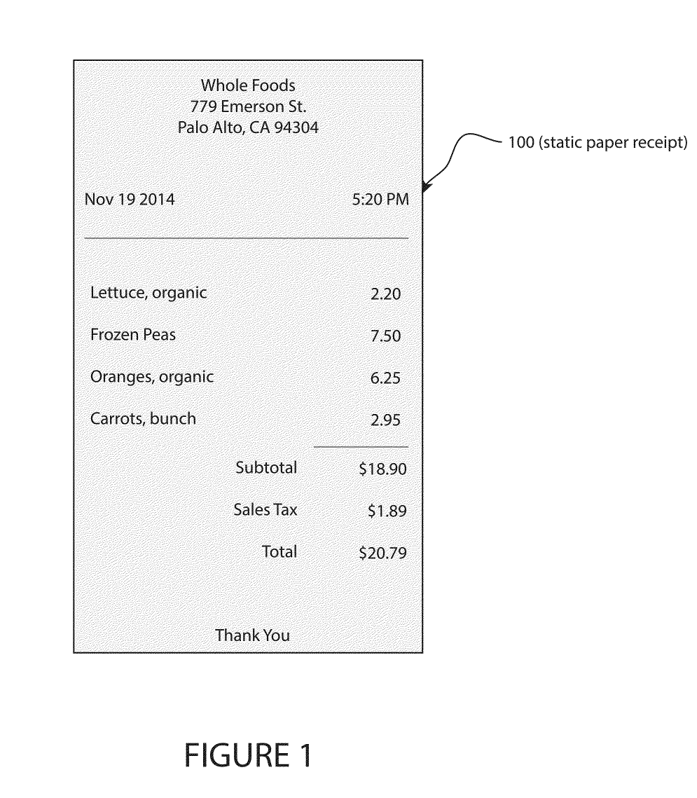

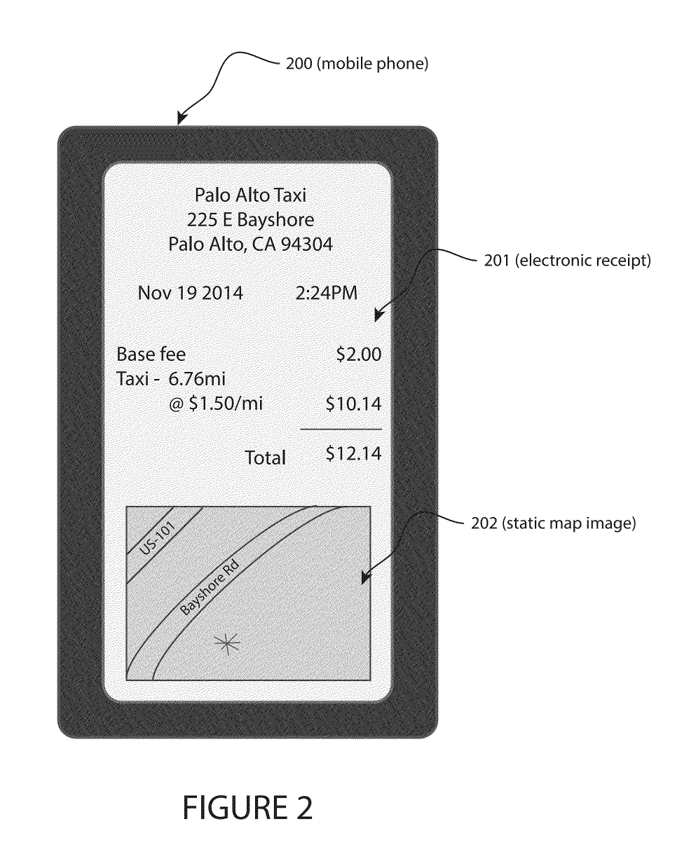

With reference to FIG. 1, a traditional receipt 100 presents a static display of transaction data. With reference to FIG. 2, an electronic receipt 201 often will present a display 200 of the transaction data enhanced with contextual information. The display may be included on a device such as a computer or mobile phone. As illustrated, the geographical location of the transaction may be shown on a map 202.

Receipts delivered in electronic form may be delivered on a computing and display device, such as a laptop, desktop computer, or mobile phone. Furthermore, receipts are often delivered either as a web page (e.g., in a browser or in a web-capable email client), or within a software application executing on the computing device. ATRs operate in this domain: the ATR may be delivered on a computing device and, optionally, may be displayed on the computing device or a display configured to operate with the computing device.

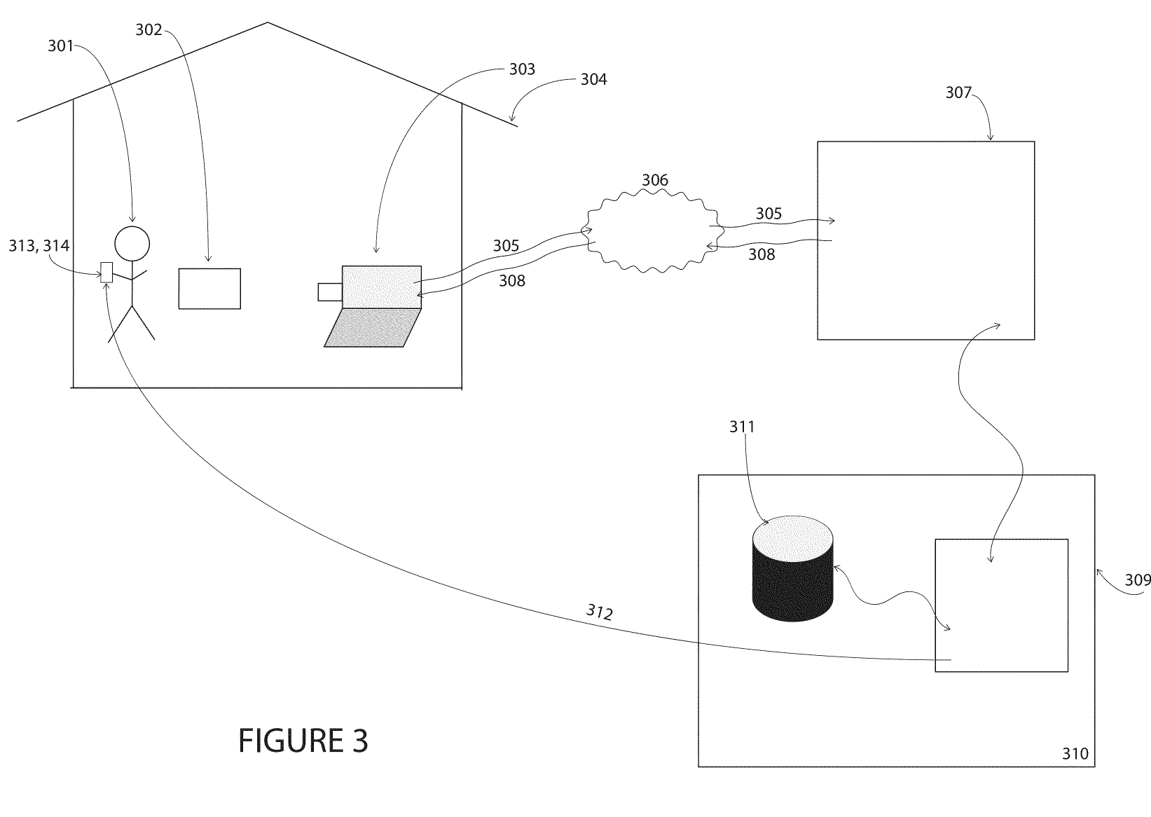

FIG. 3 shows a schematic illustration of an example configuration of a payment system, including a customer 301 using a payment card 302 at a POS 303 residing at a merchant 304 to initiate a transaction. The POS 303 may send the network transaction data 305 to the payment processor 307 via the payment network 306. In turn, the payment processor 307 may respond by providing response data 308 to the POS 303. Further, the payment processor 307 may provide the transaction data 309, to a service provider 310. Transaction data 309 may consist of the network transaction data 305 identically, a subset of the network transaction data, the network transaction data 305 with some specific elements replaced by other values determined by the payment processor 307, the network transaction data 305 augmented by additional data provided by the payment processor 307, or any combination of these possibilities. Examples of a service provider include, but are not limited to, a bank offering a mobile banking application to the customer, or a budgeting service providing spending advice to the customer. In FIG. 3, the service provider 310 may accept the transaction data 309 from the payment processor 307, analyze the transaction data 309 on an application processing system 311, store the transaction data 309 in a database 312, create a resulting representation (“result”) 313 of the transaction and deliver the result 313 to a mobile application 314 executing on the customer's mobile phone 315 via a wireless network such as a cellular data network or a WiFi network.

The result 313 may be a set of data that informs the mobile application 314 of the characteristics of the transaction and the context of the transaction, such that the mobile application 314 may create and present an ATR to the user. One common form of result may be a JSON (JavaScript Object Notation) document, sent from the service provider 310 to the mobile application 314 using a HTTPS connection over a wireless cellular data network.

In some embodiments, the service provider's 310, application processing system 311, database 312, and mobile application 314 may be referred to as the ATR system.

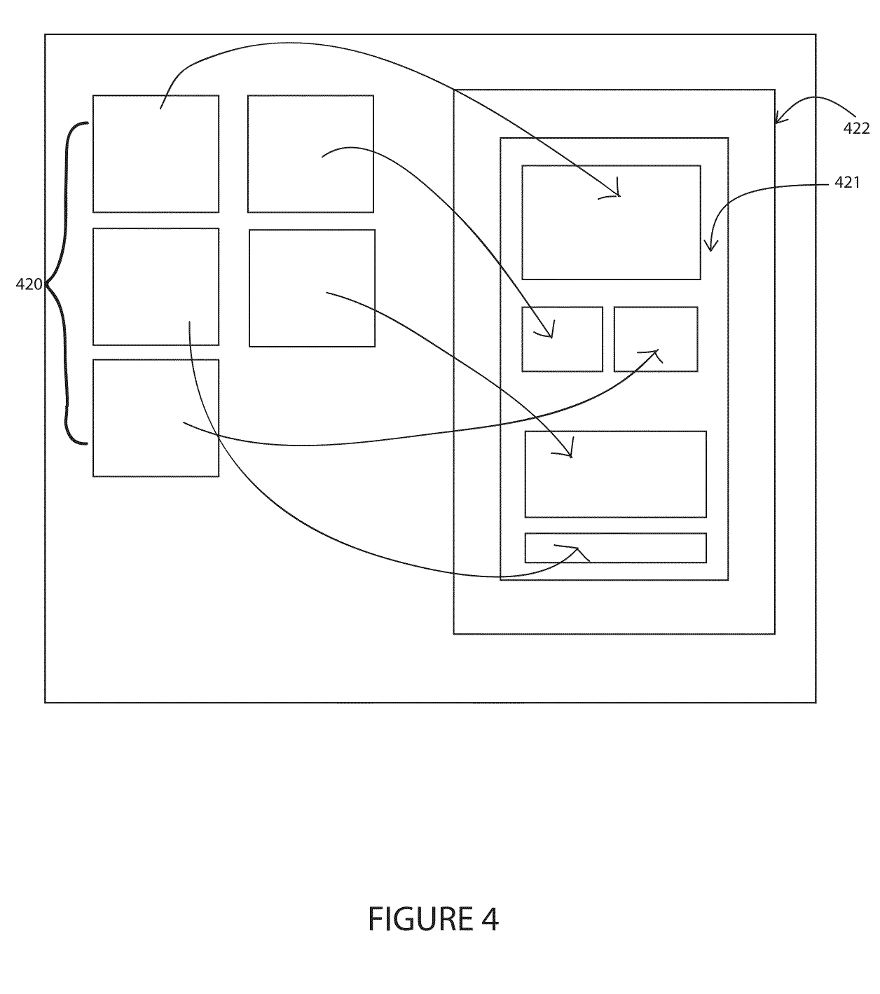

An example schematic block diagram of a mobile application configured to execute on a mobile phone is shown in FIG. 4. When the mobile application receives a result, such as the result 313 of FIG. 3, the mobile application may provide (e.g., generate) and store a set of objects 420 in memory. The mobile application may determine which objects 420 to create based on the result 313 received from the service provider 310. Objects 420 may include, but are not limited to, software classes, such as Objective-C or C++ classes instantiated in memory on the mobile phone. The mobile application may further organize these objects 420 into a representation of a receipt 421, the active transaction receipt (ATR), which may in turn be displayed on the screen 422 of the mobile phone on which the application is executing.

The executable instructions for the mobile application may be stored on one or more computer readable media located on one or more devices, such as a mobile device. Accordingly, computer readable media as used herein includes any number of computer readable media. Computer readable media may include any form of computer readable storage or computer readable memory, transitory or non-transitory, including but not limited to, externally or internally attached hard disk drives, solid-state storage (such as NAND flash or NOR flash media), tiered storage solutions, storage area networks, network attached storage, and/or optical storage. Instructions stored on the computer readable media 123 may be executed on any number of processors or other processing units.

In an ATR, the objects created are determined based on the transaction data in combination with none, some of, or all of the contextual information. As a result, a different set of objects may be created during each transaction. Furthermore, in an ATR, at least one of the objects in the set of objects will be an object that allows interaction with the user, with external subsystems or both. External subsystems may include other applications on the computing device running the application that generates the ATR and/or other systems that interact with the service provider (309).

An example of an ATR with an object that allows interaction with the user is an

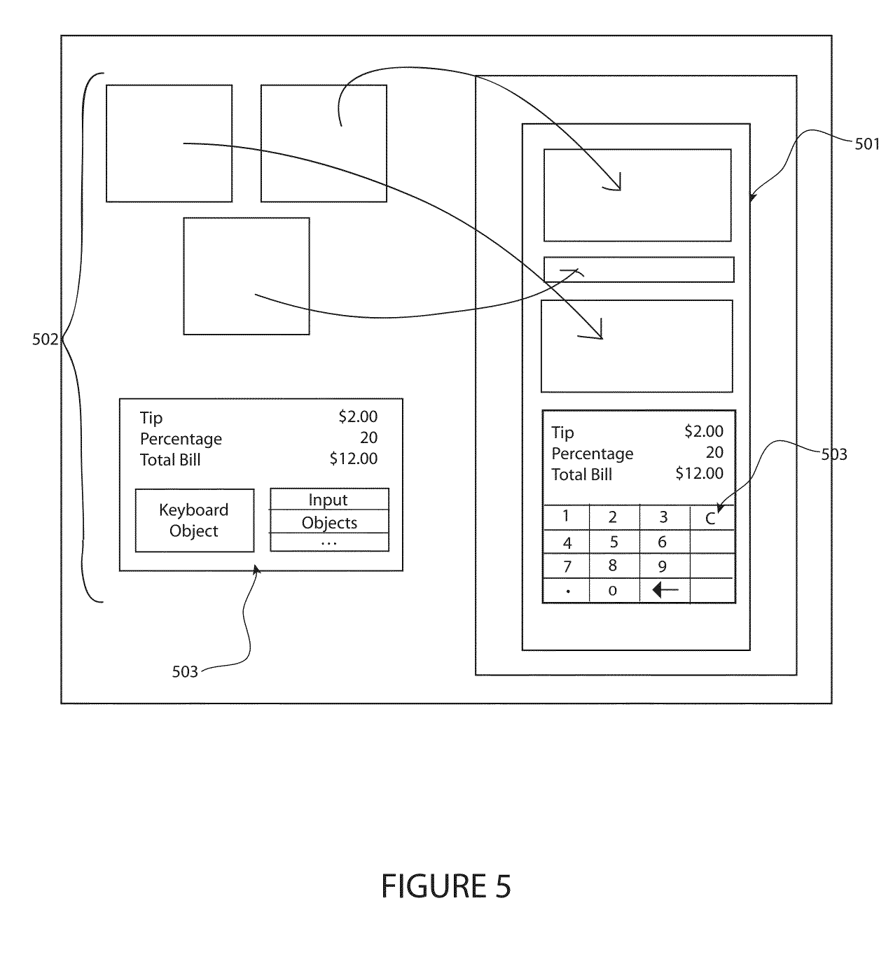

ATR representation of a transaction at a restaurant. Typically, restaurants are designated with a Merchant Category Code (MCC) of 5812. When the software application (e.g., the mobile application of FIG. 4) generating the ATR objects determines it is creating a receipt for a restaurant (MCC 5812) transaction, the mobile application may add an object that presents a “tip calculator” to the user, thereby allowing the user to calculate a tip to be added to the bill to achieve a desired percentage gratuity. FIG. 5, for example, shows such an ATR (element 501). In constructing ATR 501, an example embodiment of the ATR system follows a representative sequence of steps. First, the transaction data and any contextual information is received and analyzed by the service provider; second, the analysis is characterized by a result, which is sent to the computing device; third, the result is used by an application running on the computing device to determine the set of objects (502) that should be created to appear in the desired representation of the transaction; fourth, the objects are organized into the actual, active representation of the transaction. Finally, fifth, the ATR is displayed to the user. It will be appreciated that these enumerated steps are presented by way of example only, and that other embodiments may include additional or fewer steps and/or may include one or more of the same steps in a different sequence. In FIG. 5, a schematic representation of the objects generated in step three is shown. The interactive object, in this case the object presenting the tip calculator, is shown as item 503.

When the ATR is presented, the user may interact with the tip calculator object and use it to calculate the desired gratuity. A further extension of the ATR capability would enhance the interactive object to store the user's selected tip amount (or, equivalently, the resulting total amount) in a database on a server at the service provider. The amount in the settlement record for the transaction received from the payment processor (307) may be easily be compared by the service provider to the user's designated amount as stored in the database and, should there be a discrepancy, the user may be alerted. In some examples, storing of the amount may also be done locally on the computing device that executes the ATR object creation and display steps.

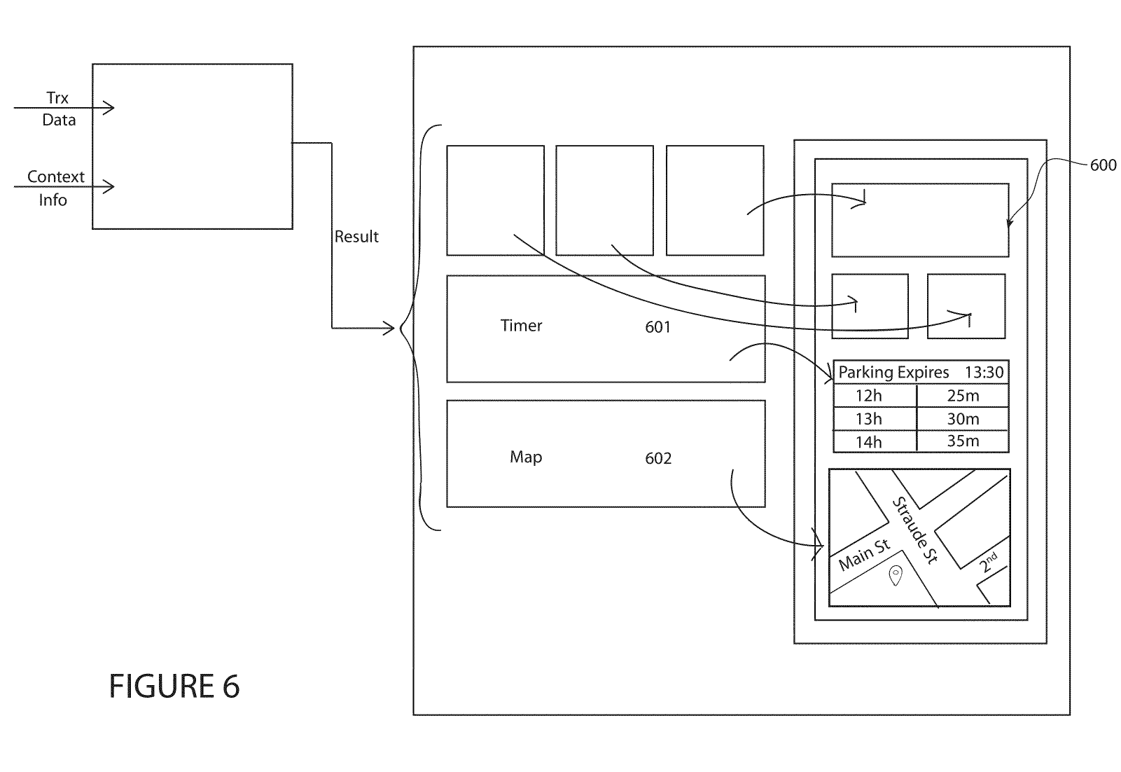

A second example further illustrates the ATR. With reference to FIG. 6, the ATR (600) represents a transaction at a parking meter or parking kiosk. The MCC for a parking meter may, for instance, be 7523. When the ATR system determines which objects should be created to represent the receipt, the ATR system may create two interactive objects. The first interactive object, a timer object (601), may present the user with an adjustable timer that the user may use to indicate the amount of time remaining until parking rights expire. The second interactive object, a map object (602), may utilize the Contexual Information (specifically, the user's GPS location at the time of the transaction) provide a map indicating where the car is parked.

In some examples, an ATR may react to user input. The user input may be provided using an object or another user interface. For example, an ATR system may receive transaction data describing a transaction initiated at a physical store (in contrast to an on-line retailer). If the transaction data contains an element indicating that the transaction was performed at a physical POS, the result may include an element indicating this as well. A mobile application processing the result may be coded to look for an element indicating that the transaction was initiated at a physical POS. When it identifies this element indicating a physical POS, it may then include, among the objects created, a map object and an object that presents a control (to be displayed on the phone screen) that the user may manipulate to indicate the accounting category for the transaction, such as “business” or “personal.” Then, if the user categorizes the transaction as “business,” the ATR may provide a field allowing the user to enter the origin of travel to the location of the transaction. When the user has so designated the origin of travel, the map object (or another object) may then use an external subsystem to calculate a driving route and distance from the origin to the location of the transaction. The user may, for example, accept this route and distance, cancel the operation, or instruct the map object to recalculate. Once the user accepts the calculated route and distance, the transaction record (or a related record) may be updated to reflect the distance traveled, which may be used by the user during tax preparation.

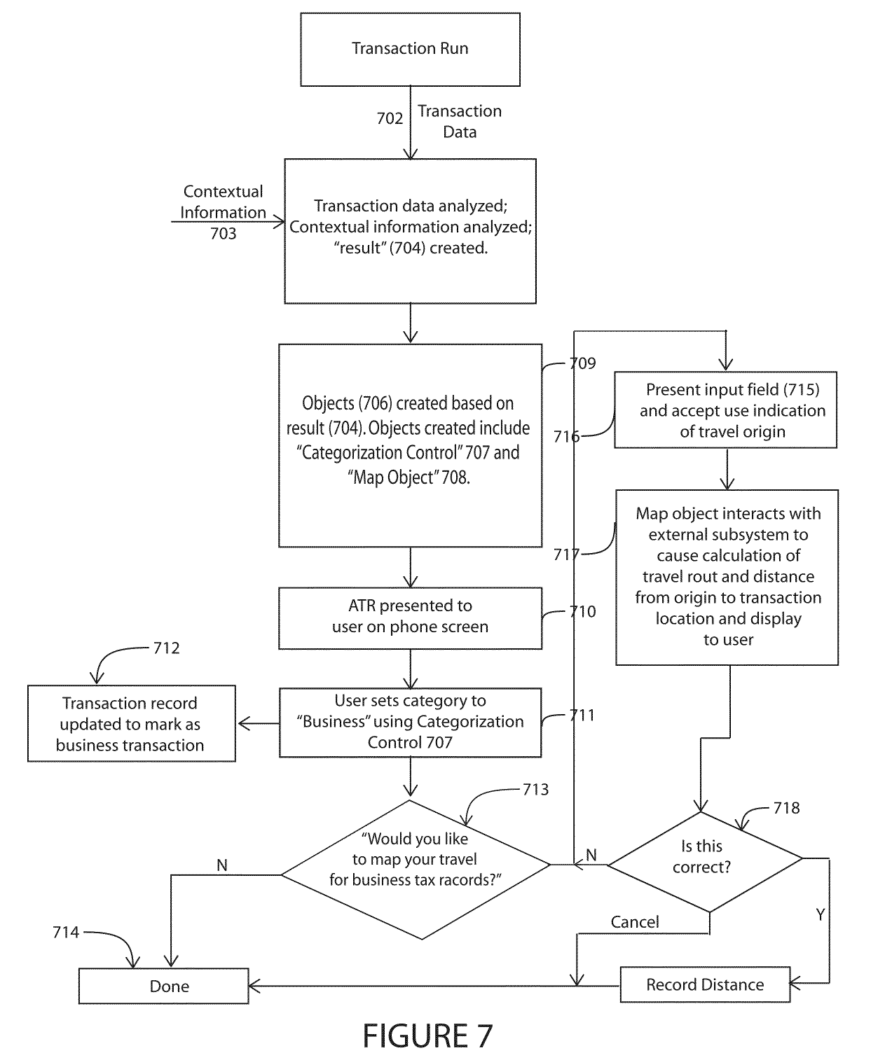

FIG. 7 shows a flow chart illustrating this example. The transaction is initiated at step 701. Transaction data 702 and contextual information 703 are analyzed, and a result 704 is created at step 705. Based on the result 704, at step 709 a set of objects is created including a “categorization control” 707 and a “map object” 708. In step 710, the ATR is organized and presented visually to the user on a mobile phone screen. The user manipulates the categorization control 707 and indicates that the transaction should be categorized as a business expense. The transaction record is updated at step 712 to reflect that it has been categorized by the user as a business transaction. At step 713, the ATR presents a dialog asking the user, “would you like to map your travel for business for tax records?” If the user selects not to map the travel, the process is complete and flow stops at step 714. If the user instead selects to map the travel, the ATR presents an input field 715 allowing the user to designate the origin of travel to the location of the transaction. The input field 715 may be a blank field in which the user can enter a verbal description, a pin the user may move on the map, and/or some other form of input field. When the user designates the origin of travel in step 716, the map object interacts (step 717) with an external subsystem to cause the calculation of a suitable route and distance from origin to transaction location; this information is then displayed to the user. At step 718, the user is asked if the calculated route and distance are correct. The user may elect to cancel the routing operation, in which case flow moves to completion at step 714. The user may elect to accept the result of the routing operation, in which case the distance is recorded in step 719. The user may elect to reject the results of the routing operation and cause recalculation; in this case, flow returns to step 716.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A system, comprising:
at least one transaction processor configured to receive transaction data describing a financial transaction and store the transaction data in a memory coupled to the at least one transaction processor, the at least one transaction processor further configured to:
analyze the transaction data;
provide a result based on the analysis;
create a set of objects in the memory based on the result;
organize the set of objects into a representation of a receipt describing the transaction; and
a display configured to provide the receipt to a user.

2. The system of claim 1, wherein at least one of the objects is created based on a value of at least one element of the transaction data.

3. The system of claim 1, wherein at least one of the objects is an interactive object.

4. The system of claim 1, wherein at least one of the objects is configured to send and receive data from external subsystems.

5. The system of claim 3, wherein the interactive object is a map.

6. The system of claim 3, wherein the interactive object is a tip calculator.

7. The system of claim 3, wherein the interactive object is a timer.

8. The system of claim 1, wherein the at least one transaction processor is further configured to receive contextual information related to the transaction data and store the contextual information in the memory, and wherein the at least one transaction processor is further configured to access the memory and analyze the contextual information.

9. The system of claim 1, wherein at least one of the objects is created conditionally based on a value of at least one element of the contextual information.

10. A method, comprising:
analyzing, with a processor, received transaction data and contextual information related to a transaction to provide a result;
analyzing the result to provide a set of objects;
organizing the set of objects into a representation of a transaction receipt; and
presenting the transaction receipt to a user using a display.

11. The method of claim 10, further comprising receiving input from the user and modifying the result based at least in part on the input from the user.

12. The method of claim 11, further comprising monitoring the transaction responsive to the input from the user.

13. The method of claim 10, wherein the set of objects includes a map, wherein the map indicates the location of the transaction.

14. The method of claim 10, wherein the contextual information includes at least one of location, time, or merchant type of the transaction.

15. The method of claim 14, further comprising presenting a calculator to the user responsive to the contextual information.

16. The method of claim 14, further comprising presenting a map to the user responsive to the contextual information.

17. A non-transitory computer readable medium encoded with executable instructions executable by a processor that when executed cause the processor to:
receive transaction data related to a transaction;
receive contextual information related to the transaction;
analyze the transaction data and the contextual information to produce a result; and
provide a result for presentation to a user on a display.

18. The non-transitory computer readable medium of claim 17, wherein the instructions further cause the processor to: accept and execute instructions provided by the user.

19. The non-transitory computer readable medium claim 18, wherein the instructions further cause the processor to monitor the transaction for a settled amount responsive to the instructions provided by the user.

20. The non-transitory computer readable medium of claim 18, wherein the instructions further cause the processor to save notes input by the user responsive to instructions provided by the user.
